(19) United States
(12) Patent Application Publication
(10) Pub. No.: US 2015/0054905 A1
(43) Pub. Date: Feb. 26, 2015

(54) IMAGE FORMING APPARATUS AND IMAGE PROCESSING METHOD

(71) Applicants: TOSHIBA TEC KABUSHIKI KAISHA, Tokyo (JP); KABUSHIKI KAISHA TOSHIBA, Tokyo (JP)

(72) Inventors: Hisashi Saino, Shizuoka-ken (JP); Hidenobu Suzuki, Shizuoka-ken (JP); Aiko Okajima, Kanagawa-ken (JP); Shigeji Kanada, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/975,538

(22) Filed: Aug. 26, 2013

(51) Int. Cl. B41J 29/36

(52) U.S. Cl. CPC B41J 29/36
USPC 347/179

(57) ABSTRACT

In accordance with one embodiment, an image forming apparatus includes a reading section configured to read an original; an information acquisition section configured to acquire color erasing times mark information specifying how to print a color erasing times mark, which is printed when a sheet on which an image is formed with a color-erasable image forming material is subjected to a color erasing processing to represent the times of color erasing processing, on a sheet; a color erasing times mark detection section configured to detect a color erasing times mark contained in the image data based on the color erasing times mark information acquired by the information acquisition section; and an image processing section configured to generate image data from which the detected color erasing times mark is eliminated.

### FIELD

Embodiments described herein relate to a copy processing and a scanning processing carried out on a sheet printed with a color erasing times mark which is printed when a color erasing processing is carried out for the sheet on which an image is formed with a color-erasable image forming material and indicating the number of times of color erasing processing.

### BACKGROUND

Conventionally, an image is formed on a sheet with a color-erasable image forming material such as a color-erasable toner. The image printed on a sheet with a color-erasable toner can be erased by a color erasing apparatus or an image forming apparatus having a color erasing processing function (hereinafter the color erasing apparatus includes the image forming apparatus having a color erasing processing function).

The color erasing apparatus prints a color erasing times mark for distinguishing the times of color erasing processing on a sheet subjected to color erasing processing. The color erasing times mark is, for example, a mark in a predetermined specific pattern. The color erasing apparatus prints a color erasing times mark at a given position of a sheet every time the color erasing apparatus carries out a color erasing processing. Then, for example, the color erasing apparatus or an image forming apparatus corresponding to a function of printing with a color-erasable toner can detect the times of color erasing processing that has been carried out on the sheet so far by reading the color erasing times mark.

If it is detected according to color erasing times marks that the times of color erasing is equal to or higher than an allowable times, the color erasing apparatus displays information ‘the sheet is not-reusable’ to a user or rejects the sheet.

On the other hand, when an original printed with a color erasing times mark is copied or scanned to generate image data, the color erasing times mark which doesn't belong to the image of the original of a reading target is also copied or included in the generated image data.

### BRIEF DESCRIPTION OF THE DRAWINGS

FIG. 1 is a block diagram illustrating a system constitution of an image forming apparatus;

FIG. 2 is a diagram illustrating an example of a printing pattern and a printing position of a color erasing times mark on a sheet;

FIG. 3 is a function block diagram illustrating functions of an image forming apparatus according to an embodiment; and

FIG. 4 is a flowchart illustrating a processing flow carried out by an image forming apparatus according to an embodiment.

### DETAILED DESCRIPTION

In accordance with an embodiment, an image forming apparatus includes a reading section, an information acquisition section, a color erasing times mark detection section and an image processing section. The reading section reads an original. The information acquisition section acquires color erasing times mark information which specifies how to print a color erasing times mark, which is printed when a sheet on which an image is formed with a color-erasable image forming material is subjected to a color erasing processing to represent the times of color erasing processing, on a sheet. The color erasing times mark detection section analyzes image data generated by the reading section by reading an original to detect a color erasing times mark contained in the image data based on the color erasing times mark information acquired by the information acquisition section. The image processing section generates, when the color erasing times mark detection section detects a color erasing times mark in the image data, image data from which the detected color erasing times mark is eliminated.

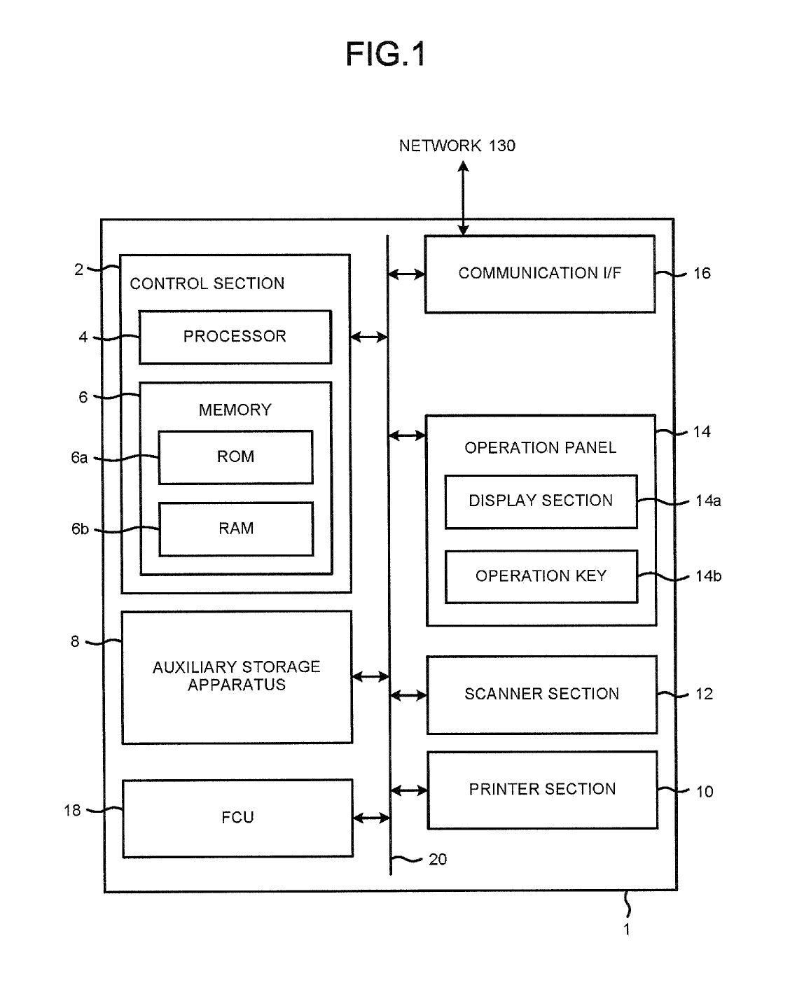

FIG. 1 is a block diagram illustrating a system constitution of an image forming apparatus 1 according to the present embodiment. The image forming apparatus 1 is an MFP (Multi Function Peripheral) having a plurality of functions such as a copy function, a print function, a scan function and a facsimile function.

First, the image forming apparatus 1 comprises a control section 2, an auxiliary storage apparatus 8, a printer section 10, a scanner section 12, an operation panel 14, a communication interface (communication I/F) 16 and a facsimile control unit (FCU) 18. Each component of the image forming apparatus 1 are connected with each other through a bus line 20.

The control section 2 functions through a processor 4, a memory 6 and an OS (Operating System).

The processor 4 is a CPU (Central Processing Unit) or an MPU (Micro Processing Unit).

The memory 6, which is, for example, a semiconductor memory, comprises: a ROM (Read Only Memory) 6a for storing a control program of the processor 4 and a RAM (Random Access Memory) 6b for providing a temporary working area to the processor 4.

The control section 2 controls the printer section 10, the scanner section 12, the operation panel 14, the communication I/F 16 and the FCU 18 based on various control programs stored in the ROM 6a or the auxiliary storage apparatus 8. The control section 2 may further comprise various image processing functions. Further, the control section 2 may include an ASIC (Application Specific Integrated Circuit) for realizing all or part of the functions of the image forming apparatus 1.

The auxiliary storage apparatus 8 stores application programs and an OS. The application programs include programs for executing the functions of the image forming apparatus 1, such as a copy function, a print function, a scan function, a facsimile function and a network file function. The application programs further include an application (Web browser) for web clients to use and other applications.

The auxiliary storage apparatus 8 stores the image data generated by the scanner section 12 by reading an original and the data acquired from an external machine connected with the communication I/F 16 via a network 130. Moreover, in the present embodiment, the auxiliary storage apparatus 8 temporarily stores the print job sent from a client terminal connected via the network 130 until the print job is executed.

The auxiliary storage apparatus 8 may be, for example, a magnetic storage apparatus such as a hard disc drive, an optical storage apparatus, a semiconductor storage apparatus (e.g. flash memory), or any combination thereof. The auxiliary storage apparatus 8 properly stores software updates, protected electronic documents, text data, account information and policy information.

The printer section 10 forms an image corresponding to the image data of the original read by the scanner section 12 and an image corresponding to the data sent from a computer such as an external client terminal via the network 130 on a sheet.

The scanner section 12 includes an internal scanning and reading unit for reading an original as an image, an original placing table and an automatic original feeding apparatus for conveying an original to a reading position. The scanning and reading unit of the scanner section 12 reads the original placed on the original placing table or the automatic original feeding apparatus.

The operation panel 14 includes a touch panel type display section 14a and various operation buttons 14b. The display section 14a displays setting content relating to printing conditions such as sheet size, number of copies, print density setting or finishing (binding, folding) and operation buttons for changing the settings. The operation buttons 14b include, for example, numeric key, a reset key, a stop key and a start key.

The communication I/F 16, which is an interface for connecting the image forming apparatus 1 with an external apparatus such as a client terminal via the network 130, is connected with an external machine via the network 130 through a proper wireless or wired communication based on IEEE802.15, IEEE802.11, IEEE802.3 and IEEE1284 such as Bluetooth (registered trademark), infrared ray connection and optical connection. The communication I/F 16 has a buffer in which part of or all the data received through the network 130 is held temporarily. The control section 2 controls the communication with a computer such as a client terminal connected via the communication I/F 16 and the network 130 and other external machine.

The facsimile control unit (FCU) 20 executes the facsimile sending and reception processing in the image forming apparatus 1.

Next, functions of the image forming apparatus 1 according to the present embodiment are described in detail. When copying an original or when scanning an original to generate image data, the image forming apparatus 1 according to the present embodiment has a function of eliminating the color erasing times mark printed on an original sheet to copy or to generate image data.

The color erasing times mark is described herein. Currently, an image forming apparatus which can form an image with a color-erasable image forming material such as a color-erasable toner is used. Further, the sheet, on which an image is formed with a color-erasable toner, can be reused as a sheet for printing after the image is erased by a color erasing apparatus capable of erasing the color-erasable toner by heating. Moreover, the color erasing apparatus may be an image forming apparatus such as an MFP having a color erasing function but is not limited to a dedicated color erasing apparatus.

Further, although the color of the color-erasable toner for image formation on a sheet is erased in a color erasing processing, the toner is still retained on the sheet. Therefore, if one sheet is repeatedly subjected to a color erasing processing and an image forming processing, then a plurality of layers of toner will be overlaid on the sheet, making it difficult to convey the sheet and to fix toner on the sheet. Thus, usually, the reuse times accompanied by the color erasing processing for a sheet is limited. In order to master the times of the color erasing processing carried out on a sheet (that is, the times of printing with a color-erasable toner), the color erasing apparatus can print a color erasing times mark on the sheet when carrying out a color erasing processing.

The color erasing times mark is printed at a specific position of the sheet, such as the outer edge of an image forming area of the sheet, which is hardly overlapped with the image of the original and can be easily distinguished from the image of the original. Further, the color erasing times mark may be in a predetermined specific pattern or shape such that it can be easily recognized.

The color erasing times mark is printed at a specific position of a sheet based on a predetermined rule every time a color erasing processing is carried out. For example, three color erasing times marks are printed at specific positions of a sheet when the image forming processing with a color-erasable toner and the color erasing processing are carried out for three times. A color erasing apparatus or an image forming apparatus capable of recognizing a color erasing times mark detects the color erasing times mark on a sheet based on a predetermined printing condition of color erasing times mark such as the pattern and the printing position of a color erasing times mark, and specifies the times of color erasing processing carried out on the sheet (that is, the times of image formation with a color-erasable toner) according to the number of the detected color erasing times marks.

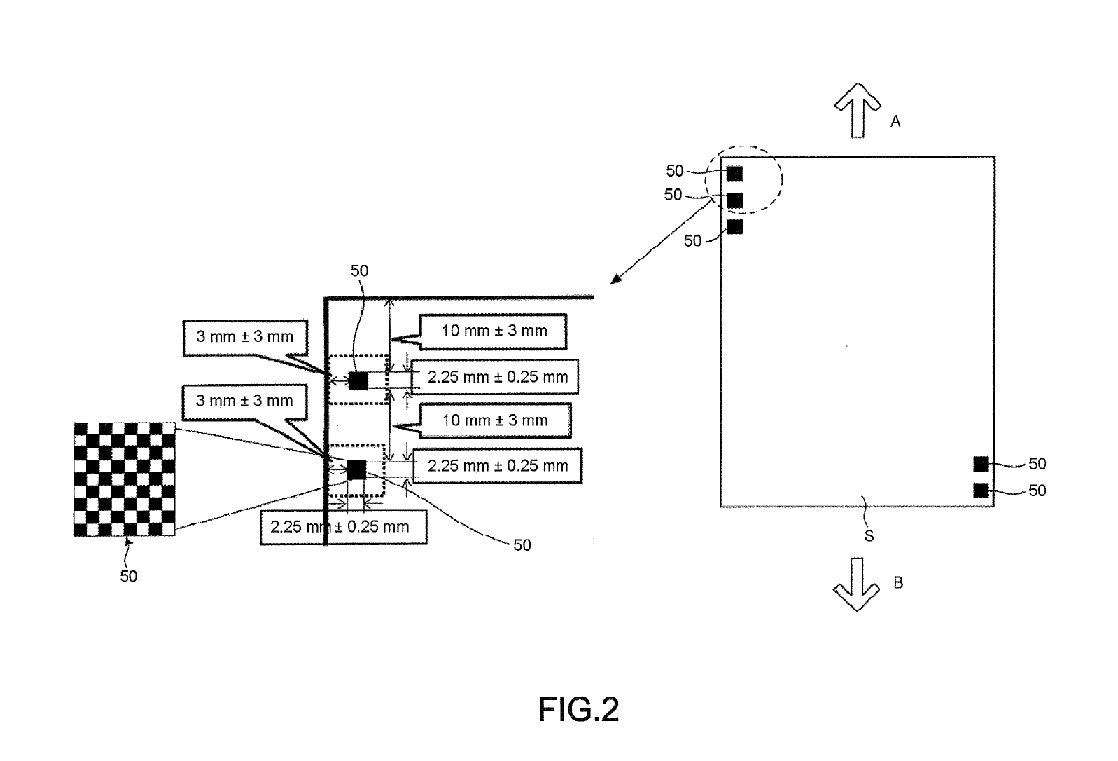

Herein, FIG. 2 illustrates an example of a printing pattern and printing position of a color erasing times mark on a sheet. In FIG. 2, a plurality of color erasing times marks 50 are printed on a sheet S, an enlarged view of part of the color erasing times marks 50 and an enlarged view of the color erasing times marks 50 representing a pattern thereof are shown on the left of FIG. 2. Further, to be distinguished easily, the color erasing times marks 50 shown on the sheet S are printed in a larger size relative to the sheet.

No specific limitation is given to the pattern of a color erasing times mark so long as it can be recognized by a color erasing apparatus. As an example, a rectangular mark which is 2 mm wide and 2 mm long is shown in FIG. 2, and the pattern of the mark is checkered pattern. Further, by registering conditions such as the size of a color erasing times mark and the size of a grid of the checkered pattern in advance, an apparatus specifying a color erasing times mark (the color erasing apparatus or the image forming apparatus 1 of the present embodiment) can determine a mark meeting the conditions is a color erasing times mark.

Further, no specific limitation is given to the printing area of a color erasing times mark on a sheet, as stated above, a printing area of a color erasing times mark can be determined in advance, and a color erasing times mark can be printed in the area. A color erasing times mark is printed when a sheet is conveyed in a color erasing apparatus for color erasing processing, and a rule is considered that a color erasing apparatus prints a color erasing times mark on the left end part of the sheet (relative to the conveyance direction of the sheet) at the upstream side of the conveyance direction of the sheet. Further, the second and the following marks are printed side by side next to the first color erasing times mark.

In FIG. 2, three color erasing times marks are printed on the left upper part of the sheet S while two color erasing times marks on the right lower part of the sheet S. Thus, if color erasing times marks are printed according to the aforementioned rule, the sheet S shown in FIG. 2 is conveyed and subjected to a color erasing processing for three times along the direction indicated by an arrow A and twice along the direction indicated by an arrow B. Thus, by reading the marks on the left upper and right lower parts, the color erasing apparatus can detect that color erasing processing is carried out on the sheet S for five times.

Further, in accordance with the present embodiment, the image forming apparatus 1 reads a sheet subjected to a copy processing, and if a printed color erasing times mark is detected, the image forming apparatus 1 eliminates the detected color erasing times mark to carry out an image forming processing (copy) on the sheet. Further, when carrying out a scanning processing to generate image data, the image forming apparatus 1 of the present embodiment similarly eliminates the color erasing times mark to generate image data.

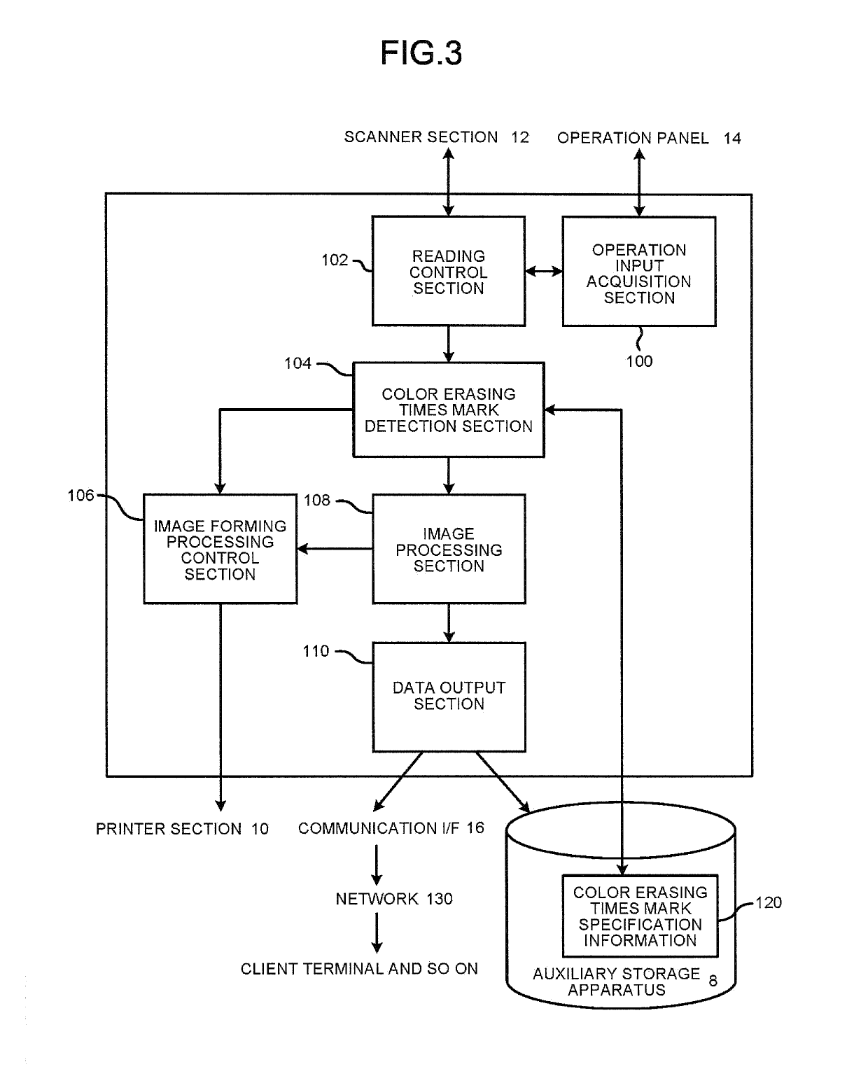

FIG. 3 is a function block diagram illustrating the functions of the image forming apparatus 1 according to the present embodiment for realizing the aforementioned processing. The image forming apparatus 1 comprises an operation input acquisition section 100, a reading control section 102, a color erasing mark detection section 104, an image forming processing control section 106, an image processing section 108 and a data output section 110.

The operation input acquisition section 100 acquires an operation input from the operation panel 14. Specifically, the operation input acquisition section 100 acquires an input carried out on the operation panel 14 instructing to execute a copy processing or scanning processing.

After the operation input acquisition section 100 acquires an input instructing to execute a copy processing or scanning processing, the reading control section 102 controls the scanner section 12 to read an original placed on the original placing table or the automatic original feeding apparatus.

If a color erasing times mark is printed on an original subjected to a copy processing or scanning processing, the color erasing times mark detection section 104 detects the color erasing times mark. In the practical processing, the color erasing times mark detection section 104 analyzes whether or not there is a color erasing times mark in a specific area of the image read for copy or scanning. Information specifying a color erasing times mark and the printing position of the color erasing times mark may be stored in, for example, the auxiliary storage apparatus 8 of the image forming apparatus 1 as color erasing times mark specification information 120. The color erasing times mark detection section 104 may determine whether or not the image of the original contains a color erasing times mark with reference to the color erasing times mark specification information 120.

The image forming processing control section 106 controls an image forming processing carried out by the printer section 10. Especially in the present embodiment, when an original containing a color erasing times mark is copied, an image of the area excluding the printing area of the color erasing times mark can be formed by the printer section 10. Specifically, for example, if it is specified that a color erasing times mark is printed on the sheet at a position at most 1 cm away from two ends of a sheet, the information representing the printing area of the color erasing times mark (area information of the color erasing times mark) is specified by the color erasing times mark specification information 120. Thus, the image forming processing control section 106 forms an image on the sheet with the image data read and generated by the scanner section 12 in a printing area (effective area) which is at least 1 cm away from two ends of the sheet based on the color erasing times mark specification information 120. Thereby, only the necessary part of the original excluding the color erasing times mark is copied on the sheet, and an area containing a color erasing times mark is not printed. In order to eliminate color erasing times marks, the size of the narrowed part of the effective area, that is, the printing area may be determined based on the color erasing times mark specification information 120 specifying printing positions of color erasing times marks. The function of the image forming processing control section 106 is a function of forming only an original image, that is, the necessary part of an original excluding the color erasing times marks by limiting the image forming range, without carrying out an image processing on the read image.

If it is detected that the original of reading target contains color erasing times marks, the image processing section 108 carries out an image processing on the image generated by reading the original to eliminate the color erasing times marks. A method used by the image processing section 108 to eliminate the color erasing times marks from the image data is, for example, the so-called trimming processing method of narrowing an area of image data to generate an image excluding color erasing times marks. If color erasing times marks are printed in a specific range of the end parts of a sheet, then the areas of end parts may be eliminated from image data. As stated above, area information specifying the printing area of color erasing times marks may be contained in the color erasing times mark specification information 120. The image processing section 108 may eliminate the printing area of color erasing times marks from the image data based on the color erasing times mark specification information 120. Moreover, when the image data area is narrowed to eliminate the color erasing times marks, the area of the image is enlarged to the size of the original image data again such that it is in the same size as the original image data.

Further, according to another method for eliminating color erasing times marks, it may be also set that only the part of each color erasing times mark is erased by specifying positions of the color erasing times marks respectively, but not uniformly eliminating the whole printing area of color erasing times marks as stated above. In the case where color erasing times marks are erased respectively, for example, the image processing section 108 erases the color erasing times marks by coloring the areas of the color erasing times marks into white, which is the ground color of the sheet. The image processing section 108 may erase the exact area of a color erasing times mark or an area containing the area of a color erasing times mark.

Further, the image processing section 108 may only erase the actually printed parts of the color erasing times marks when erasing the color erasing times marks respectively. That is, for example, if a color erasing times mark is a character such as a letter, then only the lines of the printed character are erased. For example, when a color erasing times mark is the checkered pattern shown in FIG. 2, the color erasing times mark can be erased by coloring the part printed in black to white.

The color erasing times mark elimination processing in the image processing performed by the image processing section 108 may be carried out on an image formed on a sheet during a copy processing or on an image generated in a scanning processing as a scanned image.

The data output section 110 sends the image data generated in a scanning processing to an external machine such as a client terminal via the communication I/F 16 or stores the image data in the auxiliary storage apparatus 8 of the image forming apparatus 1. In the present embodiment, the image data from which the color erasing times marks are eliminated by the image processing section 108 are sent to an external client terminal by the data output section 110, or stored in the auxiliary storage apparatus 8.

Above is description on the function relating to the processing carried out by the image forming apparatus 1 of the present embodiment when copying or scanning an original printed with color erasing times marks.

Next, the flow of the copy or scanning processing carried out by the image forming apparatus 1 of the present embodiment on an original containing color erasing times marks is described below.

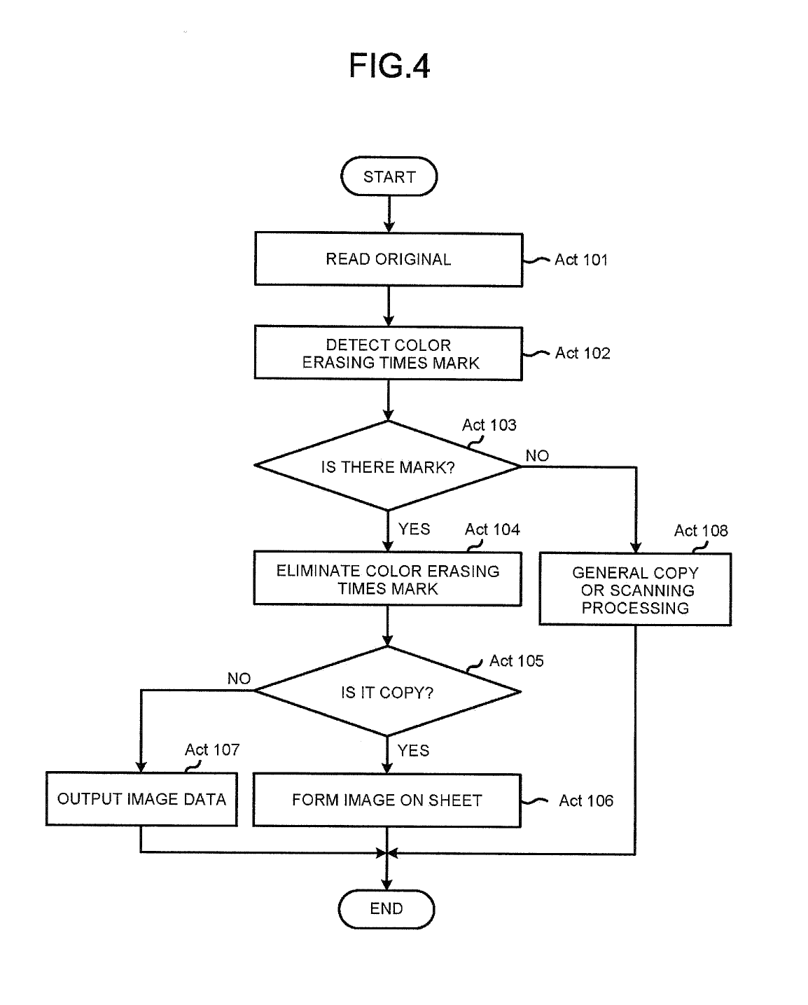

FIG. 4 is a flowchart illustrating a copy or scanning processing flow according to the present embodiment. Moreover, in the flowchart of FIG. 4, a method of eliminating the color erasing times marks is described as an example of eliminating the printing area of the color erasing times marks by narrowing the area of the image data scanned through an image processing.

First, if the operation input acquisition section 100 acquires an input instructing to execute a copy or scanning processing from the operation panel 14, the reading control section 102 enables the scanner section 12 to read an original of a reading target (ACT 101).

Next, the color erasing times mark detection section 104 analyzes the image data generated by the scanner section 12 by reading an original to detect color erasing times marks (ACT 102).

If the color erasing times mark detection section 104 determines that color erasing times marks exist in the image data (YES in ACT 103), the image processing section 108 narrows the area of the generated image to carry out an image processing of eliminating the area in which the color erasing times marks are printed (ACT 104).

Further, in the case of a copy processing (YES in ACT 105), the image forming processing control section 106 enables the printer section 10 to carry out an image forming processing based on the image data from which the area of the color erasing times marks is eliminated in ACT 104 (ACT 106). In the case of a scanning processing (NO in ACT 105), the data output section 110 outputs the image data from which the color erasing times marks are eliminated in ACT 104 to an external apparatus or stores the image data in a storage apparatus (ACT 107).

If the color erasing times mark detection section 104 determines that there is no color erasing times mark in ACT 103 (NO in ACT 103), then a general copy or scanning processing is executed (ACT 108).

Above is the flow of a method for carrying out a copy or scanning processing in the image forming apparatus 1 of the present embodiment. Moreover, a color erasing times mark may be eliminated by another processing method mentioned above. For example, in the case of a copy processing, instead of carrying out the image processing described in ACT 104 on the image data, the image forming processing control section 106 may also narrow the printing area of the printer section 10 to eliminate the printing area of a color erasing times mark, thereby carrying out a copy processing. Further, as another method in image processing, the color erasing times marks may be respectively erased.

Further, if the color erasing times mark detection section 104 detects color erasing times marks in ACT 103, a screen is displayed on the display panel 14 to notify that the color erasing times marks are contained in the original, and a screen is displayed to confirm whether or not to erase the color erasing times marks to copy or to generate a scanned image. When a user confirmation is carried out and an instruction of erasing processing is input, a color erasing times mark is erased by any of the aforementioned methods. On the other hand, if an instruction of “not erase” is input, a copy processing or an image data generating processing is carried out as usual.

In accordance with the present embodiment above, when a sheet which is printed with a color-erasable image forming material such as a color-erasable toner and on which a color erasing times mark indicating times of color erasing is printed is copied or scanned by a scanner, a copy or scanning processing can be carried out after eliminating the color erasing times mark which does not belong to the original image of the original. Typically, when an original is copied or scanned, since the color erasing times mark is an unnecessary image, only the necessary image part is copied or scanned even if the original contains a color erasing times mark according to the present embodiment.

Moreover, the image forming apparatus 1 is described as an MFP in the present embodiment, however, the present invention is not limited to this, an image forming apparatus having at least one of a copy function and a scan function is applicable.

Further, although a color-erasable toner is described as a color-erasable image forming material in the present embodiment, the functions of the present embodiment are not limited by the category of the color-erasable image forming material. For example, the image forming material may be a color-erasable ink used in an inkjet image forming apparatus.

(Modification 1)

Next, a modification of the embodiment is described. In the modification, when the color erasing times mark detection section 104 detects that a color erasing times mark exists, the image processing section 108 carries out an image processing of erasing the color erasing times mark from the generated image, then carries out a further image processing after the erasing processing. Specifically, the image processing section 108 carries out processing of completing the erased part based on the image around the erased color erasing times mark. For example, in the case where a color erasing times mark is printed on a colored part or a part in certain pattern, if the part of the color erasing times mark is erased and colored to white, then the difference between the part of the mark and the part around the mark becomes conspicuous. Thus, the image processing section 108 analyzes the image around the erased color erasing times mark, estimates the original image of the part from which the color erasing times mark is erased, and completes the erased part to make the erased part look the same as the part around it. Specifically, for example, the image processing section 108 copies the pixels of the part around the color erasing times mark and pastes the pixels in the area of the erased color erasing times mark, thereby completing the erased part.

Further, as another method for completing the erased color erasing times mark, the image processing section 108 may also paste other given image. For example, a logo of the company of a user may be registered in the auxiliary storage apparatus and the like in advance as an image for completion, and the image processing section 108 may paste the logo image in the erased part to complete the erased part.

In accordance with the modification, even if a color erasing times mark is erased, a copy processing or a scanned image data generation processing can be carried out while the erased part looks the same as the part around it.

(Modification 2)

This embodiment is another modification of the embodiment. When a color erasing times mark is detected in the image generated by reading an original, the image forming apparatus 1 of the present modification further comprises a mark information addition section configured to generate information specifying the color erasing mark in the image and add the information to the generated image data, instead of eliminating the color erasing mark using the image processing section 108. The information specifying a color erasing times mark refers to, for example, position information representing the position where the color erasing times mark is formed in image data.

Thus, in the present embodiment, when an original printed with a color erasing times mark is scanned to generate image data, the data output section 110 sends the image data added with information specifying the color erasing times mark generated by the image processing section 108 to an external client terminal or stores the image data in the auxiliary storage apparatus of the image forming apparatus 1. Then, another computer such as the client terminal can eliminate the color erasing times mark from the image data later using the information specifying the color erasing times mark added to the image data. Even in the case where the color erasing times mark is eliminated later, the color erasing times mark can be eliminated easily using the information specifying the color erasing times mark on the sheet.

In the present embodiment, the functions of the present invention are recorded in the apparatus in advance, however, the present invention is not limited to this, the same functions may also be downloaded to the apparatus from a network or stored in a recording medium and then installed in the apparatus. The form of the recording medium is not limited as long as the recording medium can store programs like a CD-ROM and is readable by an apparatus. Further, the function realized by an installed or downloaded program can also be realized through the cooperation with an OS (Operating System) installed in the apparatus.

As stated above, according to the technology described herein, there is provided an image forming apparatus which carries out an image forming processing of eliminating an undesired color erasing times mark when an original containing color erasing times marks is copied or scanned to generate image data.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus, comprising:
a reading section configured to read an original;
an information acquisition section configured to acquire color erasing times mark information which is about a color erasing times mark indicating the number of times of color erasing processing to print on the sheet when a color erasing processing is carried out for the sheet on which an image is formed with a color-erasable image forming material and for specifying a condition of printing on a sheet;
a color erasing times mark detection section configured to analyze image data generated by the reading section by reading an original to detect a color erasing times mark contained in the image data based on the color erasing times mark information acquired by the information acquisition section; and
an image processing section configured to generate, when the color erasing times mark detection section detects a color erasing times mark in the image data, image data from which the detected color erasing times mark is eliminated.

2. The image forming apparatus according to claim 1, further comprising:
an image forming processing control section configured to control a processing of forming an image on a sheet based on the image data which is generated by the image processing section and from which a color erasing times mark is eliminated.

3. The image forming apparatus according to claim 1, further comprising:
an image forming processing control section configured to control, in the case where the color erasing times mark detection section detects a color erasing times mark in the image data, the processing of forming an image on a sheet after eliminating an area of the color erasing times mark in the image data generated by the reading section by reading an original.

4. The image forming apparatus according to claim 1, wherein
the color erasing times mark information contains area information specifying an area for printing the color erasing times mark on a sheet; and
the image processing section generates image data from which the area for printing the color erasing times mark is eliminated based on the area information contained in the color erasing times mark information when the color erasing times mark detection section detects a color erasing times mark.

5. The image forming apparatus according to claim 1, further comprising:
a mark information addition section configured to generate, when the color erasing times mark detection section detects a color erasing times mark in the image data, information at least containing position information specifying the position of the detected color erasing times mark in the image data generated by the reading section by reading an original and add the information generated for the generated image data.

6. An image processing method, including:
reading an original;
acquiring color erasing times mark information which is about a color erasing times mark indicating the number of times of color erasing processing to print on the sheet when a color erasing processing is carried out for the sheet on which an image is formed with a color-erasable image forming material and for specifying a condition of printing on a sheet;
analyzing image data generated by reading an original to detect a color erasing times mark contained in the acquired image data based on the color erasing times mark information; and
generating, when a color erasing times mark is detected in the image data, image data from which the detected color erasing times mark is eliminated.

7. The image processing method according to claim 6, including:
forming an image on a sheet based on the image data from which the color erasing times mark is eliminated.

8. The image processing method according to claim 6, including:
forming, when the color erasing times mark is detected in the image data, an image on a sheet after the area of the color erasing times mark in the image data generated by reading an original is eliminated.

9. The image processing method according to claim 6, wherein
the color erasing times mark information contains area information specifying an area for printing the color erasing times mark on a sheet, including:
generating, when a color erasing times mark is detected in the image data, image data from which an area for printing the color erasing times mark is eliminated based on the area information contained in the color erasing times mark information.

10. The image processing method according to claim 6, further including:
generating, when the color erasing times mark is detected in the image data, information at least containing position information specifying a position of the color erasing times mark in image data generated by reading an original and adding the information to the generated image data; and
generating image data from which the detected color erasing times mark is eliminated based on the information added to the image data.
